(19) United States
(12) Patent Application Publication
(10) Pub. No.: US 2003/0017421 A1
(43) Pub. Date: Jan. 23, 2003

(54) Holographic grating fabrication using mirror with surface curvature

(76) Inventor: Miri Park, New Providence, NJ (US)

Correspondence Address: CHRISTIE, PARKER & HALE, LLP, 350 WEST COLORADO BOULEVARD, SUITE 500, PASADENA, CA, 91105, US

(21) Appl. No.: 09/909,409

(22) Filed: Jul. 18, 2001

(51) Int. Cl. G03H 1/04

(52) U.S. Cl. 430/321; 430/1; 430/2; 359/35; 359/30

(57) ABSTRACT

A method and apparatus for forming a device in a substrate having grating structure, includes a substantially coherent and collimated light source, a mirror having a non-planar surface, and a substrate. The mirror, substrate, and stationary light source are disposed in fixed position with respect to one another. The components are arranged such that some light beams from the light source are projected directly onto the substrate surface and other light beams are reflected from the mirror surface onto the substrate surface. The respective beams converge at the substrate surface at different interference angles across the substrate surface. The different interference angles produce an interference pattern having a varying interference period which preferably uniformly increases or decreases across the substrate. The corresponding grating structure formed within the substrate using this interference pattern, therefore also includes the varying grating period. The device formed in the substrate may be a laser.

### FIELD OF THE INVENTION

The present invention relates most generally to semiconductor lasers. More particularly, the present invention provides a method and apparatus for forming grating structures used in conjunction with semiconductor lasers and other structures.

### BACKGROUND OF THE INVENTION

Grating structures are used in conjunction with distributed feedback (DFB) lasers, distributed Bragg reflector (DBR) structures and other mirror and laser structures formed in the semiconductor and optoelectronic industries. More particularly, grating structures are used to form portions of the above mirror and laser structures. A grating structure includes a repeating sequence of materials having different refractive indices. In an exemplary embodiment, the grating structure is formed of an alternating sequence of adjacent lines formed of different materials on a substrate. A grating period is defined as the width of the two adjacent lines in the alternating sequence. DFB lasers, for example, may use the grating structure, also referred to as a grating reflector, to select the lasing wavelength of the laser light. A standard DFB laser may include grating periods equivalent to approximately ½ of the wavelength of the light being propagated. By changing or interrupting the grating period, the wavelength of the propagated light may be changed.

It is therefore critical to accurately produce grating structures having the desired grating period or periods. Grating structures are commonly formed on substrates using E-beam or holographic methods to produce an alternating series of adjacent lines which may include lateral dimensions as small as 10 nanometers. E-beam technologies are very expensive and time-consuming. Conventional holographic techniques are rather difficult to control, especially when producing arrays of grating structures which include multiple grating periods.

Holographic techniques involve two coherent light beams (e.g. lasers) of the same wavelength and amplitude which are each directed to a particular surface of interest, preferably a substrate coated with a photosensitive material. If the beams are completely in phase at the point they converge, constructive interference occurs and the intensity at that point is twice the intensity of a single beam. If the light beams are completely out of phase at the point they converge, however, destructive interference occurs and the light intensity at that particular point will be zero, meaning that there is no illumination. When coherent light beams having the same wavelength and amplitude are directed to converge onto a surface at different angles, an interference pattern is formed across the surface. The resulting interference pattern in the illuminated region therefore consists of a regularly varying intensity pattern. Alternating high and low intensity regions are produced depending on whether the light beams are in phase or out of phase. Whether or not the convergent, interfering light beams are in or out of phase depends, in turn, upon the beam length difference of the beams at the particular point on the surface. The interference pattern is formed as a result of the regularly changing beam length of light beams from the fixed light sources, along the substrate surface being illuminated. In this manner, the two converging, interfering beams regularly vary from being in phase and out of phase across the substrate surface.

As such, when parallel beams from a substantially coherent light source are directed onto a surface both directly and as beams reflected from a mirror, the produced interference pattern will comprise alternating regions of high and low intensity sections. In the extreme case for light being completely in and completely out of phase, the adjacent high and low intensity regions will essentially be illuminated and non-illuminated regions, respectively. A period of such an interference pattern, defined as an adjacent pair of high and low intensity regions, is related to the angle between the two beams according to the following equation:

d=w/[2sin(θ/2)]

in which d is the length of the period, w is the wavelength of the coherent incoming light beams and θ is the interference angle between the two incoming light beams.

Therefore, if a flat mirror surface is positioned in a fixed location with respect to the substrate on which the interference pattern is being formed, the angle θ, and therefore, the period d will remain fixed as long as the light source is also in fixed position with respect to the mirror and the surface being illuminated. In this manner, an interference pattern with a constant interference period can be formed in a photosensitive material formed on a substrate surface.

A grating structure is formed by etching, or otherwise translating the interference pattern into the substrate. It is desirable to produce a grating structure having a varying grating period on the surface of a single substrate for a number of reasons. The actual grating period needed to produce the desired lasing wavelength may turn out to be different than predicted due to unpredicted variations in the fabrication process for forming the laser. Also, different grating periods may be desired for producing lasers having different lasing wavelengths on a single substrate. Moreover, process control limitations in forming the grating structure itself may render an entire substrate useless if the precisely desired lasing wavelength is not produced. In that case, producing grating structures having different grating periods on the same substrate precludes having to scrap the entire substrate.

The present invention addresses the shortcomings of conventional holographic techniques used to form grating structures and provides a mechanically simple method and apparatus to holographically produce a grating structure having a varying grating period over the surface of a substrate. The grating period varies across the substrate surface and is achieved using a single stationary light source and illuminating stage, and using a single exposure process.

### SUMMARY OF THE INVENTION

The present invention provides a method and apparatus using holographic techniques, to produce a device on a substrate having a grating structure which includes a grating period which varies over the surface of the substrate. The apparatus includes a substantially coherent and collimated light source, a mirror having a curved surface, and a planar substrate surface preferentially coated with a photosensitive material. The components are arranged such that the light beams are directed onto the substrate surface directly from the light source and are also reflected from the curved mirror surface onto the substrate surface. The interference pattern is formed on the substrate surface by the convergent beams which are directed onto the surface and angled with respect to one another. The curved mirror surface is arranged to produce an interference angle between the interfering, convergent beams, which varies across the surface of the substrate and therefore produces a grating period which varies across the surface of the substrate.

It is to be understood that both the foregoing general description and the following detailed descriptions are exemplary but not restrictive of the invention.

### BRIEF DESCRIPTION OF THE DRAWING

The invention is best understood from the following detailed description when read in conjunction with the accompanying drawing. It is emphasized that, according to common practice, the various features of the drawing are not to scale. On the contrary, the dimensions of the various features and the relative dimensions and locations of the features are arbitrarily expanded or reduced for clarity. The following figures are included in the drawing.

FIG. 1 is a cross-sectional view showing convergent beams which produce an interference pattern according to the PRIOR ART;

FIG. 2 is a plan view of an arrangement for forming a grating structure with a constant grating period on a substrate, according to the PRIOR ART;

FIG. 3 is a plan view of an exemplary embodiment showing an arrangement for forming a grating structure having a varying grating period on a substrate according to the present invention;

FIG. 4 is a plan view of another exemplary embodiment for forming a grating structure having a varying grating period on a substrate according to the present invention;

FIG. 5 is a plan view of another exemplary embodiment for forming a grating structure having a varying grating period on a substrate according to the present invention;

FIG. 6 is a plan view of yet another exemplary embodiment for forming a grating structure having a varying grating period on a substrate according to the present invention;

FIG. 7 is a plan view of still another exemplary embodiment for forming a grating structure having a varying grating period on a substrate according to the present invention;

FIG. 8 is a perspective view showing an exemplary arrangement of the curved mirror and substrate according to the present invention;

FIG. 9 is a plan view showing an interference pattern having a varying interference period formed on a substrate;

FIG. 10 is a cross-sectional view showing an interference pattern formed in the photosensitive material formed on the substrate;

FIG. 10A is an expanded view of part of the structure shown in FIG. 10;

FIG. 11 is a cross-sectional view showing a developed grating pattern formed on a substrate; and,

FIG. 12 is a cross-sectional view showing an exemplary grating structure formed in the substrate.

### DETAILED DESCRIPTION OF THE INVENTION

The present invention provides a manufacturable and mechanically simple method and apparatus for forming grating structures on substrates using a stationary, coherent, and collimated light source, a mirror having a non-planar, generally arcuate surface, and a substrate having a photosensitive material formed on its surface.

Now turning to the figures, FIG. 1 shows two light beams 109 and 111, which converge at point 112 on surface 113 of substrate 103. Light beams 109 and 111 include the same wavelength and amplitude. If beams 109 and 111 are in phase at point 112, constructive interference occurs and point 112 is a high intensity point and is illuminated. If beams 109 and 111 are out of phase at point 112, destructive interference occurs and point 112 will be a low intensity point. If beams 109 and 111 are completely out of phase at point 112, then they cancel and the intensity at point 112 is zero. An important factor in determining whether the beams are in or out of phase is the beam length which varies across the surface for light directed at an angle from a single stationary source. For example, if constructive interference occurs at point 112, destructive interference resulting in complete cancellation of the light beams, may occur at points 114 and 116 disposed laterally from point 112 on surface 113. The period of the interference pattern is related to the interference angle between the two convergent light beams. Angles θ₁′ and θ₂′ are the angles which light beams 109 and 111, respectively, make with the normal to planar substrate surface 113. The interference angle θ₀′ is equal to θ₁′ plus θ₂′.

In this embodiment, surface 113 is coated with photosensitive coating 119, which may be photoresist in the preferred embodiment. It can be seen that angles θ₁′, and θ₂′ of the respective light beams in the photosensitive material 119, are related to corresponding angles θ₁, and θ₂, according to Snell's law. For purposes of simplicity, however, it will be assumed that interference angles θ₀′ and θ₀ are equal. It should be understood, however, that the actual period of the interference pattern formed in a photoresist film having a non-negligible thickness will be adjusted based on the relative refractive indices of air and the photosensitive material, n₀ and n₁, respectively, in accordance with Snell's law. The interference period consisting of high intensity region and an adjacent low intensity region, therefore, is related to the interference angle according to the following expression:

$$d = \frac{w}{2 sin ( {θ}_{o} / 2 )}$$

in which w is the wavelength of the incoming light, θ₀ is the interference angle between the convergent beams and d is the distance of the interference period, i.e. the distance across the high intensity region and the adjacent low intensity region.

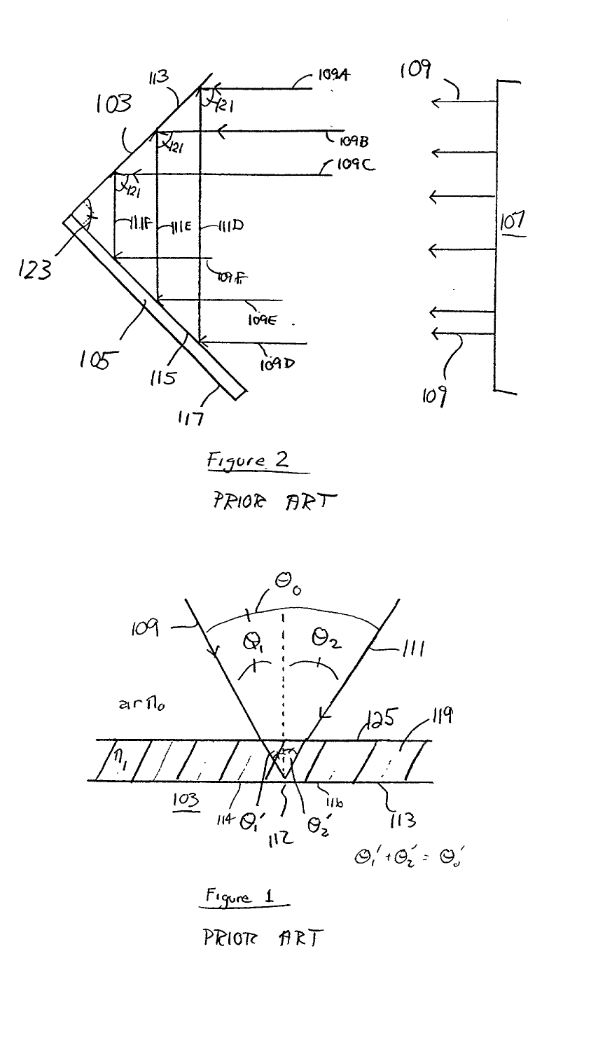

FIG. 2 shows a Prior Art arrangement for forming an interference pattern from which a grating pattern will be formed, on a substrate. Collimated light source 107 and flat mirror 105 including planar mirror surface 115 are used to direct beams such as 109A, 109B, and 109C directly onto surface 113 of substrate 103, and also to reflect light beams such as 111D, 111E, and 111F from planar mirror surface 115 onto substrate surface 113. According to the conventional technology, interference angles 121 formed between direct beams 109A, 109B, and 109C, and reflected beams 111D, 111E, and 111F, respectively, are the same since the angles each beam makes with respect to the normal to surface 113, are unchanged. As such the interference pattern and therefore the subsequent grating pattern formed on surface 113 of substrate 103 will have the same grating period, d, across the entire surface 113 of substrate 103.

An exemplary embodiment of an arrangement of the present invention is shown in FIG. 3. FIG. 3 is a top view showing substantially coherent light source 7, mirror 5A, and substrate surface 13 of substrate 3. Exemplary mirror 5A includes a non-planar curved surface 15A and opposed base surface 17 which is substantially planar and orthogonal with respect to substrate surface 13 which is substantially planar in the preferred embodiment. In the exemplary embodiment, mirror 5A is continuously convex along direction 19 which is substantially orthogonal to substrate surface 13. In this exemplary embodiment, angle 23 is a 90-degree angle. In the exemplary embodiment shown, curved surface 15A is symmetrically curved along direction 19 which extends from a point on mirror surface 15A closest to substrate 13 to a point on mirror surface 15A furthest from substrate surface 13. Curved surface 15A may be asymmetrical according to other exemplary embodiments.

Substantially coherent light source 7 produces collimated light, including a number of parallel beams 9 having substantially the same wavelength, w. An expanded illumination area is used to insure that light beams from light source 7 are directed both directly onto substrate surface 13 and as reflected from mirror surface 15A onto substrate surface 13. According to an exemplary embodiment, light source 7 may be a UV laser emitting light having a 3638 angstrom wavelength, but various other light sources may be used according to other exemplary embodiments.

When light source 7 is powered, each of light source 7, curved mirror 5A, and substrate 3 are in fixed position with respect to one another. It can be seen that direct beams 9D, 9E, and 9F are directed straight from light source 7 onto substrate surface 13 and make the same angle with substrate surface 13. Light beams 9A, 9B, and 9C, however, are directed onto curved surface 15A of mirror 5A. Each of beams 9A, 9B, and 9C are reflected off mirror surface 15A at the same but opposite angle with respect to the normal of the surface at the point the respective light beam hits the surface. In the preferred embodiment, mirror surface 15A will have a reflectivity of 1 so that the intensity of the reflected light beams will essentially be the same as the intensity of the direct beams. Reflected light beams 11A, 11B, and 11C converge with direct beams 9D, 9E, and 9F, respectively. Interference angle 29 is formed between reflected light beam 11C and direct light beam 9F. Interference angle 27 is formed between reflected light beam 11B and direct light beam 9E. Interference angle 25 is formed between reflected light beam 11A and direct light beam 9D. Direction 21 represents the direction along substrate surface 13 extending from a point on substrate surface 13 nearest mirror 5A to a point on substrate surface 13 furthest mirror 5A. It can be seen that along direction 21 moving away from mirror 5A, interference angles, 29, 27, and 25, become increasingly larger, even though the angles which direct beams 9D, 9E, and 9F make with substrate surface 13 remain constant. In this manner, interference period d becomes increasingly smaller along direction 21. Since curved mirror surface 15A is curved continuously and smoothly, it can be seen that the interference angles continuously increase along direction 21. The positioning and size of curved mirror surface 15A will preferably be chosen such that the entirety of substrate surface 13 will be illuminated with reflected beams from curved mirror surface 15A. It should also be understood that curved surface 15A is exemplary only, and the positioning of mirror 5A adjacent substrate 3 is exemplary only. The orthogonal orientation between base surface 17 and substrate 3 is a preferred embodiment, but the present invention is not limited to such an orientation.

It should again be emphasized at this point that relative features such as the curvature of the curved mirror surface have been expanded for clarity. In the preferred embodiment, interference angles 29, 27, and 25 may lie within the range of 95.88° to 100.26°. In an exemplary embodiment in which a substantially coherent light source having a wavelength of 3638 angstroms is used, such a range of interference angles produces an interference period ranging from 2450 angstroms to 2370 angstroms on substrate surface 13. Other ranges of interference periods may be achieved according to other exemplary embodiments.

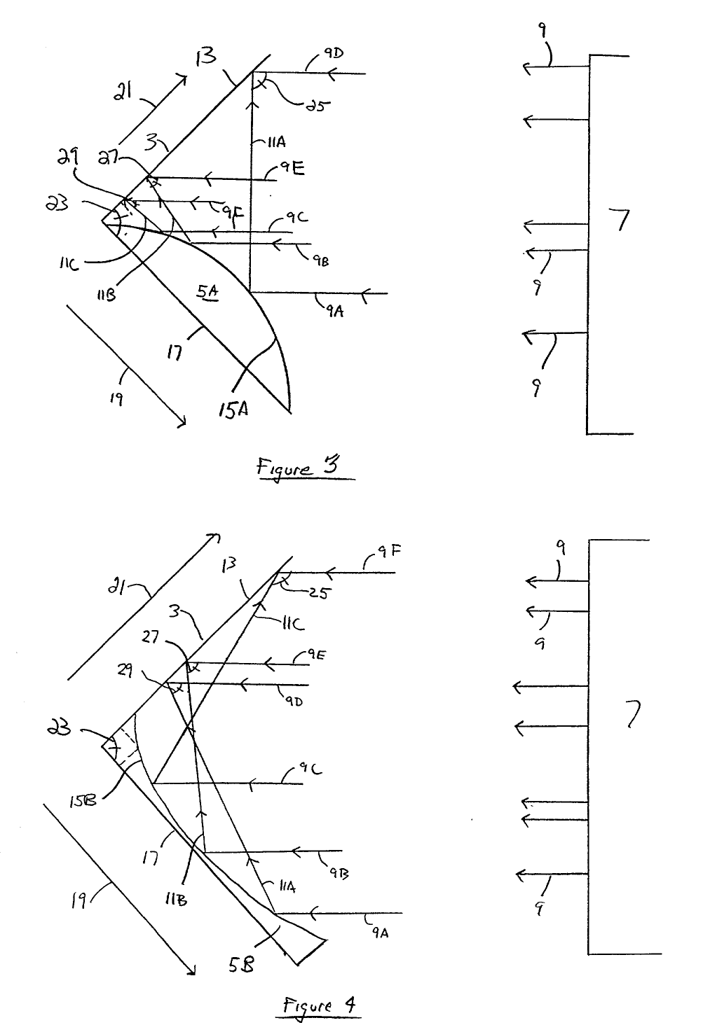

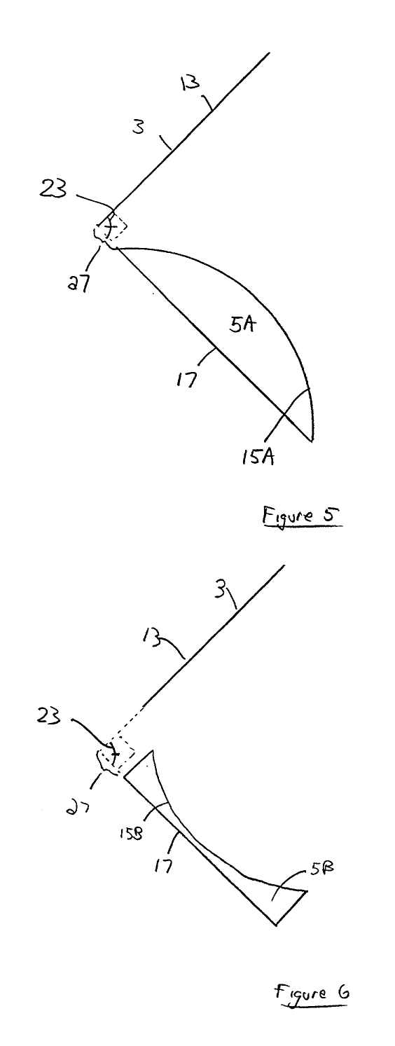

Now turning to FIG. 4, another exemplary embodiment of mirror 5B having curved mirror surface 15B, is shown. In the exemplary embodiment, substantially planar base surface 17, formed opposite curved mirror surface 15B, is substantially orthogonal to substantially planar substrate surface 13. Curved mirror surface 15B is a symmetrically concave surface and is curved uniformly and continuously along direction 19 which, in the exemplary embodiment, is orthogonal to substrate surface 13, and more generally represents the direction extending from a portion of the mirror surface nearest the substrate to a further portion of the mirror surface furthest the substrate. As described in conjunction with FIG. 3, substantially parallel light beams 9 are directed both directly onto substrate surface 13 and indirectly onto substrate surface 13 by means of reflection off curved mirror surface 15B. Interference angles 29, 27, and 25 formed between direct and reflected beam pairs 9D and 11A, 9E and 11B, and 9F and 11C, respectively, become increasingly larger along direction 21 which in the exemplary embodiment is orthogonal to base surface 17, and more generally represents a direction extending from the portion of substrate 3 nearest mirror 5B to the portion of substrate 3 furthest mirror 5B. As such, interference angles 29, 27, and 25, steadily increase along direction 21 and therefore interference period d becomes steadily smaller along the direction leading away from mirror 5B. Various other exemplary arrangements for forming a varying interference period based upon a varying interference angle between convergent reflected and direct light beams, are contemplated.

It should again be emphasized at this point that relative features such as the curvature of the curved mirror surface have been expanded for clarity. As in the exemplary embodiment shown in FIG. 3, interference angles 29, 27, and 25 may lie within the range of 95.88° to 100.26°. In an exemplary embodiment in which a substantially coherent light source having a wavelength of 3638 angstroms is used, such a range of interference angles would produce an interference period ranging from 2450 angstroms to 2370 angstroms, but interference periods of other ranges may be produced alternatively.

Now referring to FIG. 5, another exemplary arrangement is shown. The arrangement in FIG. 5 is substantially similar to the arrangement shown in FIG. 3, except that mirror 5A is not adjacent substrate 3 as in FIG. 3. Rather, space 27 separates mirror 5A and substrate 3.

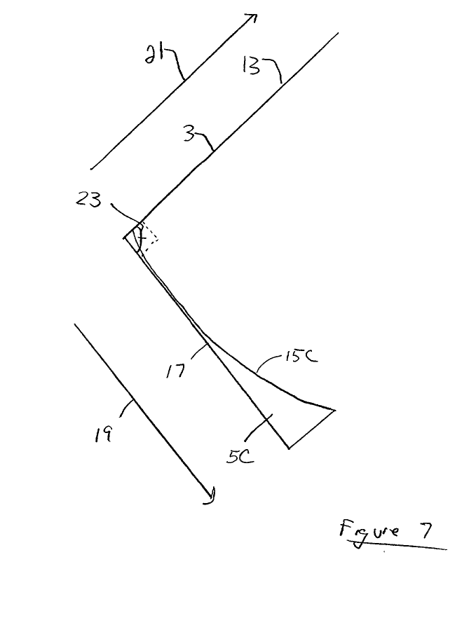

Similarly, FIG. 6 shows an arrangement similar to the arrangement shown in FIG. 4. Again, the exception here is that mirror 5B is not in contact with, or adjacent to substrate 3. In each of FIGS. 5 and 6, it can be seen that base surface 17 formed opposite the curved mirror surfaces 15A and 15B, respectively, is substantially planar and orthogonal to substrate surface 13. Each of mirrors 5A and 5B shown in FIGS. 5 and 6, include symmetrically curved mirror surfaces. Each of the arrangements is chosen such that substantially coherent and parallel light beams from a fixed light source (not shown) having a substantially wide illumination area, will illuminate mirror surfaces 15A, 15B and produce a set of convergent beams across the entirety of substrate surface 13.

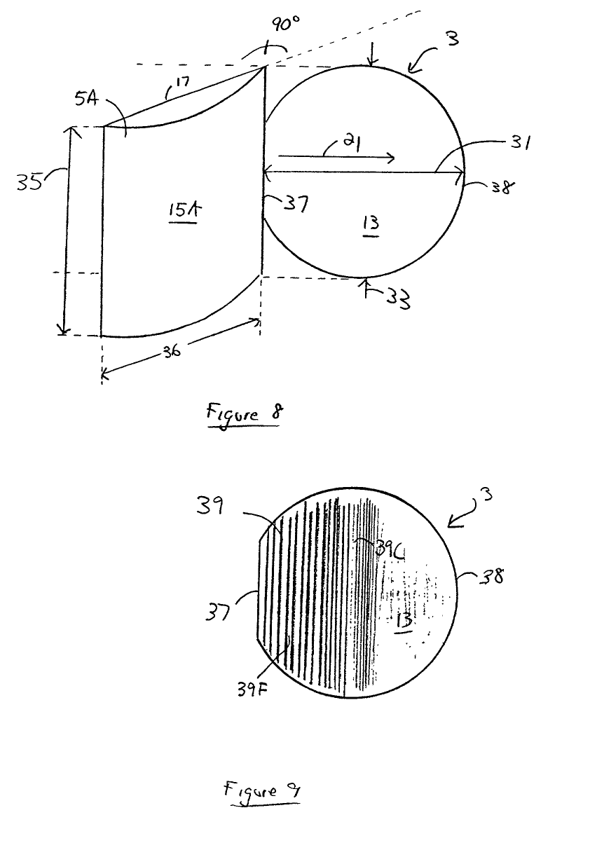

According to yet another exemplary embodiment such as shown in FIG. 7, mirror 5C may include mirror surface 15C, which is not symmetrically curved. Curved mirror surface 15C is curved along previously defined direction 19. Furthermore, base surface 17 of mirror 5C formed opposite curved mirror surface 15C is not orthogonal with surface 13 of substrate 3. According to this exemplary embodiment, angle 23 formed between the surfaces is not a 90° angle.

Various other exemplary arrangements are anticipated in order to produce convergent direct and reflected beams having an interference angle which varies along direction 21 extending away from an arcuate mirror such as exemplary mirror 5C as in FIG. 7. According to the preferred embodiment, the mirror will be shaped and arranged such that the interference period, d, either continuously increases or decreases along direction 21.

FIG. 8 is a perspective view generally illustrating the mirror-substrate arrangement shown in FIG. 3. Substrate 3 may be a conventional wafer such as commonly used in the optoelectronics fabrication industry. Substrate 3 includes wafer flat 37 and wafer round 38. According to the preferred embodiment, substantially planar substrate surface 13 is configured orthogonal to base surface 17 of mirror 5A. In the preferred embodiment, wafer flat 37 is positioned adjacent mirror 5A but other arrangements may be used. In this manner, direction 21 along which the interference period preferentially uniformly increases or decreases, extends from wafer flat 37 to wafer round 38. Width 36 of mirror 5A is preferably chosen to insure that the entirety of substrate surface 13 will be illuminated by the reflected beam as well as the direct beam. Height 35 is preferably chosen to be greater than or equal to dimension 33 of substrate 3. In this manner, the interference pattern is formed on the entire substrate surface 13. According to other exemplary embodiments, other arrangements may be used and the interference pattern may not extend over the entirety of substrate surface 13.

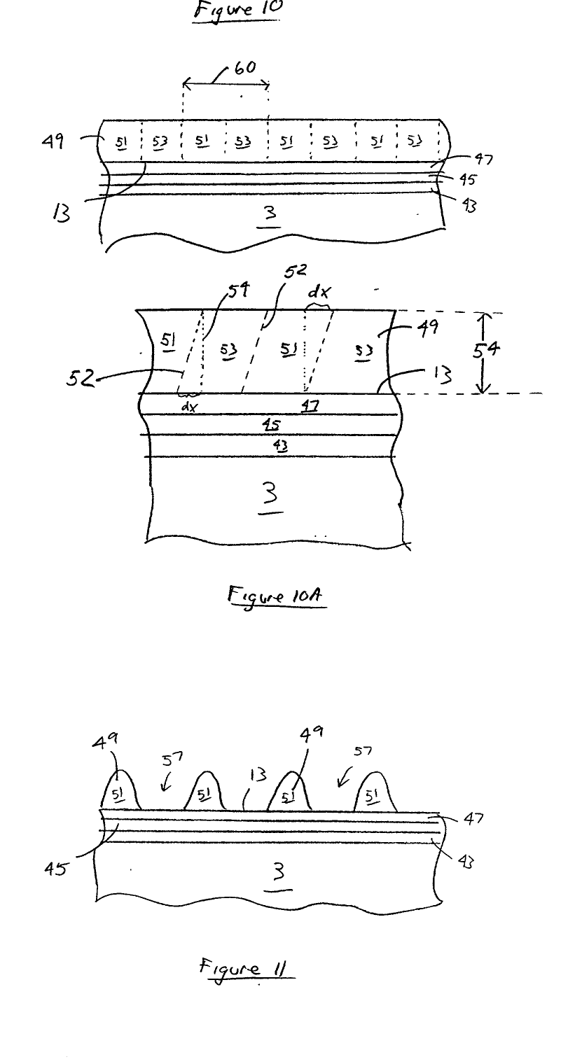

The method of the present invention includes forming a photosensitive material over substrate surface 13 prior to arranging substrate 3 in fixed position with respect to the mirror and light source. Conventional methods may be used to form a photosensitive material on substrate surface 13. According to a preferred embodiment, photoresist such as commonly used in the semiconductor and optoelectronics manufacturing industry, may be used. Negative or positive photoresist may be used. After the photosensitive material is formed on substrate surface 13, substrate 3 is positioned in fixed location with respect to the exemplary mirror and light source. Various conventional means may be used to secure the components into their fixed positions. The stationary light source is then illuminated forming an exemplary interference pattern which preferably includes a grating period which increases or decreases regularly along direction 21. A single exposure may be used. The interference pattern includes alternating strips of exposed and unexposed photosensitive material in which each alternating strip extends essentially orthogonally with respect to direction 21 extending from a point on surface 13 nearest mirror 5A to a point on surface 13 furthest mirror 5A. The exposed regions correspond to high intensity regions and the unexposed regions correspond to low intensity regions, of an interference pattern. FIG. 9 shows such an interference pattern.

FIG. 9 is a plan view of an exemplary interference pattern 39 formed on surface 13 of exemplary substrate 3. In the exemplary embodiment shown, substrate 3 may be a wafer and the period of interference pattern 39 decreases along the direction extending from wafer flat 37 to wafer round 38. For example, interference period d is greater in region 39F than in region 39C. According to a preferred embodiment, the interference period may vary across substrate 3 and may include interference periods ranging from 2450 angstroms to 2370 angstroms. In an exemplary embodiment, the actual variation of the interference period across substrate 3 may be on the order of 10-40 angstroms, but other ranges may be produced alternatively. Other exemplary interference periods and interference period range variations may be used alternatively.

FIG. 10 is a cross-sectional view showing an exemplary interference pattern formed over a substrate. An interference pattern consisting of alternating exposed regions 53 and unexposed regions 51 is formed in photosensitive material 49 over substrate surface 13 of substrate 3. Substrate surface 13 is the upper surface of top layer 47 and substrate 3 includes bottom layer 43, intermediate layer 45, and top layer 47 in the exemplary embodiment. According to other exemplary embodiments, more or fewer layers may be used. Bottom layer 43 may be InP, intermediate layer 45 may be InGaAs or InGaAsP, and top layer 47 may be InP according to the exemplary embodiment but other materials may be used alternatively. It will be seen that the grating period is formed by removing alternating sections of the film stack of top layer 47, intermediate layer 45 and bottom layer 43 in the areas in which photosensitive material 49 has been developed away. In the exemplary embodiment, photosensitive material 49 may be a positive photoresist film such that exposed regions 53 will subsequently be developed away. Interference period 60 includes a pair of adjacent exposed 53 and non-exposed 51 regions.

It should be understood that the exemplary interference period shown in FIG. 10 represents a small localized section of the interference pattern formed in photosensitive material 49 and in which interference period 60 is relatively constant throughout the small segment shown. It should be emphasized, however, that a salient aspect of the present invention is that interference period 60 varies across the substrate surface as shown in FIG. 9.

FIG. 10A is an expanded view showing additional features of the structure shown in FIG. 10. Previously discussed equation d=w/(sin(θ₀/2)) applies to the interference period formed along the difference vector formed by the two beams which converge at a given point and are separated by angle θ₀. Referring again to FIG. 1, the two angles θ₁ and θ₂ which combine to form θ₀, may not be equal angles with respect to the normal to surface 113. If they are not equal, the difference vector formed by the two convergent beams will not be along planar substrate surface 13. Rather, the difference vector and therefore alternating exposed regions 53 and unexposed regions 51 may be angled with respect to substrate surface 13 as shown by dashed lines 52 which separate exposed regions 53 from unexposed regions 51. It has been found, however that for a finite photosensitive material thickness 54 of about 500Å, and for an interference angle ranging from 95.88 degrees to 100.26 degrees, as in the preferred embodiment, dx is less than about 10 angstroms. The actual period produced in the substrate surface, using various techniques such as etching, may vary negligibly from the period produced along the difference vector in the photosensitive material. This is negligible compared to the width of interference period 60 which will range from 2370 angstroms to 2450 angstroms in the preferred embodiment in which interference angles are maintained in the range within 95.88 degrees to 100.26 degrees. The value of dx may vary to a negligible degree, across the substrate.

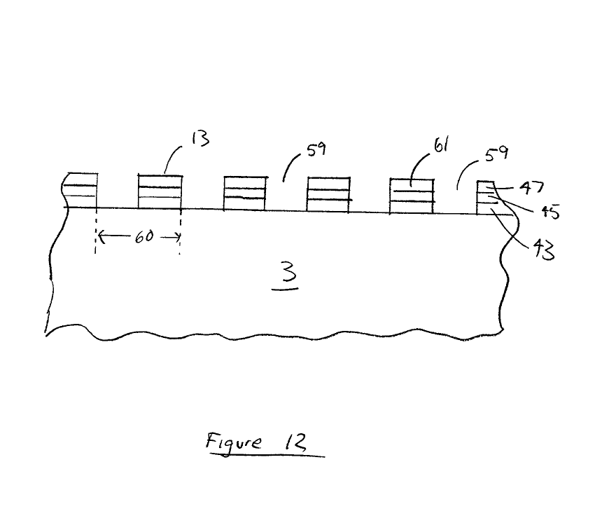

FIG. 11 shows the structure from FIG. 10 after the photosensitive material has been developed. According to the preferred embodiment in which the photosensitive material is a positive photoresist, exposed areas 53 shown in FIG. 10 are developed away. Conventional developing methods may be used. With exposed sections 53 developed away, open sections 57 are formed exposing substrate surface 13. Photosensitive material 49 remains within unexposed regions 51. Conventional etching techniques may be performed upon the structure shown in FIG. 11 to remove portions of top layer 47, intermediate layer 45 and bottom layer 43 in unexposed regions 51. The remaining sections of photosensitive material 49 may be removed to produce the structure shown in FIG. 12.

FIG. 12 shows a grating structure formed within substrate 3. The grating structure includes a grating period 60. The grating structure includes alternating regions of void areas 59 and stacked structures 61. Stacked structure 61 includes portions of top layer 47, intermediate layer 45, and bottom layer 43. A DFB laser that includes a grating structure such as shown in FIG. 12 is capable of tuning lasers to various lasing wavelengths depending on the distance of grating period 60 and the other physical characteristics of the laser. It is to be emphasized again that the truncated structure shown in FIG. 12 comprises a small section of the grating period formed according to the present invention. As previously noted, distance 60 of the grating period varies across the substrate surface.

After the varying grating period is formed over the substrate surface according to the apparatus and method of the present invention, conventional measurement techniques can be used to accurately measure the grating period. Various and numerous regions of the substrate can be measured to determine the grating period at that location. Void areas 59 may be subsequently filled with various materials as desired so that alternating strips of material of different refractive indexes, are produced along the substrate surface. Conventional dicing techniques can then be used to dice the substrate to produce various grating structures for various applications.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. For example, various substrates may be used upon which to form the varying grating structures of the present invention. Various films may be formed on the substrate to constitute the grating structure such as shown in FIG. 12. Various other shapes and configurations of a mirror surface may be used and positioned in various other arrangements with respect to the substrate.

Moreover, all statements herein reciting principles, aspects, and embodiments of the invention, as well as specific examples thereof, are intended to encompass both structural and functional equivalents thereof. Additionally, it is intended that such equivalents include both currently known equivalents, such as equivalents described in the future, i.e., any elements developed that perform the same function, regardless of structure. The scope of the present invention, therefore, is not intended to be limited to the exemplary embodiment shown and described herein. Rather, the scope and spirit of the present invention is embodied by the appended claims.

What is claimed is:

1. An apparatus for forming a grating structure having a varying grating period on a substrate, comprising:
a substrate having a substantially planar substrate surface;
a mirror having a non-planar mirror surface and in fixed position with respect to said substrate; and
a substantially coherent light source of parallel beams configured to direct light beams onto each of said mirror surface and said substrate surface, said mirror configured such that said light beams directed onto said mirror surface are reflected from said mirror surface and onto said substrate surface.

2. The apparatus as in claim 1, in which said mirror includes a substantially planar base surface opposite said non-planar mirror surface and said base surface is disposed orthogonally with respect to said substrate surface.

3. The apparatus as in claim 1, in which said mirror surface is arcuate.

4. The apparatus as in claim 2, in which said mirror surface is curved along the direction orthogonal to said substrate surface.

5. The apparatus as in claim 2, in which said mirror surface is convex along the direction orthogonal to said substrate surface.

6. The apparatus as in claim 2, in which said mirror surface is concave along the direction orthogonal to said substrate surface.

7. The apparatus as in claim 1, in which said mirror surface is symmetrically curved along a direction extending from a portion of said mirror surface nearest said substrate to a further portion of said mirror surface furthest said substrate.

8. The apparatus as in claim 1, wherein said substrate comprises a wafer having a flat and said mirror is disposed adjacent said flat.

9. The apparatus as in claim 1, wherein said substrate surface is coated with a photosensitive material, and said mirror is configured such that an interference pattern of adjacent exposed and unexposed regions, is formed within said photosensitive material.

10. The apparatus as in claim 9, in which said interference pattern includes an interference period which varies across said substrate surface.

11. The apparatus as in claim 9, in which said non-planar mirror surface is symmetrically curved along the direction orthogonal to said substrate surface, and the interference pattern includes an interference period which one of gradually increases and gradually decreases across said substrate surface.

12. The apparatus as in claim 11, in which said interference period one of gradually increases and gradually decreases along the direction extending from a point on said substrate surface nearest said mirror to a further point on said substrate surface furthest from said mirror.

13. The apparatus as in claim 1, in which said substrate includes a width and a substrate height, said width defined as the dimension along the direction extending from a point on said substrate surface nearest said mirror to a further point on said substrate surface furthest said mirror, and said mirror includes a mirror height greater than or equal to said substrate height.

14. The apparatus as in claim 1, in which said substantially coherent light source of parallel beams is stationary.

15. The apparatus as in claim 1 in which the interference period, d, is determined by d=w/[2sin(θ/2)], where w is the wavelength of light from said light source and θ is the interference angle between a beam directed from said light source to said surface and a reflected beam reflected from said mirror surface onto said surface; and in which varies across said surface.

16. The apparatus as in claim 1, wherein the light source comprises an ultraviolet laser emitting light having a wavelength of about 3638 angstroms.

17. The apparatus as in claim 4, in which the mirror surface includes a curvature chosen to produce a grating period which varies and lies within the range of about 2370 angstroms to about 2450 angstroms.

18. A method for forming a device on a substrate having a varying grating period, comprising the steps of:
providing a substrate having a substantially planar substrate surface;
forming a photosensitive material over said substrate surface;
providing a mirror having a curved mirror surface and a substantially coherent light source which produces substantially parallel light beams;
positioning said mirror in fixed position with respect to said substrate and said light source such that some of said substantially parallel light beams from said light source are directed directly onto said substrate surface and some of said substantially parallel light beams are directed onto said mirror surface and are reflected from said mirror surface onto said substrate surface; and
illuminating said light source thereby directing said parallel beams from said light source onto said substrate surface and onto said mirror surface such that each of direct beams and reflected beams arrive at said substrate surface thereby creating an interference pattern in said photosensitive material.

19. The method as in claim 18 wherein said interference pattern comprises alternating strips of exposed photosensitive material and unexposed photosensitive material, each alternating strip extending orthogonally with respect to the direction extending from a point on said substrate surface closest said mirror to a further point on said substrate surface furthest said mirror.

20. The method as in claim 19, further comprising the steps of developing said interference pattern and etching said interference pattern into said substrate.

21. The method as in claim 20, in which said substrate includes a film stack formed on said substrate surface and said etching comprises etching said film stack.

22. The method as in claim 18, in which said positioning comprises orienting said mirror such that said curved mirror surface is curved along the direction extending from a proximate point of said mirror situated closest to said substrate, to a distal point of said mirror situated furthest from said substrate.

23. The method as in claim 18, wherein said step of illuminating comprises a single exposure.

24. The method as in claim 18, further comprising selecting a mirror surface having a curvature configured to produce an interference period which one of steadily increases and steadily decreases along a direction extending from a point on said substrate surface nearest said mirror to a further point on said substrate surface furthest said mirror.

25. The method as in claim 18, wherein said device comprises a laser.
